(19) United States
(12) Patent Application Publication
(10) Pub. No.: US 2009/0297879 A1
(43) Pub. Date: Dec. 3, 2009

(54) Structure and Method for Reliable Solder Joints

(75) Inventors: Kejun ZENG, Coppell, TX (US); Rajiv DUNNE, Murphy, TX (US); Masood MURTUZA, Sugar Land, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/463,517

(22) Filed: May 11, 2009

Related U.S. Application Data
(60) Provisional application No. 61/052,499, filed on May 28, 2008.

(51) Int. Cl. B32B 15/16; B32B 15/01; B32B 15/20; B23K 1/20

(52) U.S. Cl. 428/647; 428/686; 428/674; 428/675; 428/660; 428/648; 228/176

(57) ABSTRACT

A solder joint (200) has a first contact pad 114 and a second contact pad 124 of a first metal, preferably copper, facing each other across a gap. A coat and 125, respectively) of a second metal, preferably nickel, covers each pad. A layer 201 of crystals of first intermetallic compounds, such as Ni₃Sn₄ and (Ni, Cu)₃Sn₄, covers the surface of each coat. Isolated crystals 202 of second intermetallic compounds, such as Cu₆Sn₅ and (Cu, Ni)₆Sn₅, different from the first intermetallic compounds, are dispersed on top of the layer 201 of crystals of the first intermetallic compounds. A solder alloy 203 including a third metal, preferably tin, and the first metal fills the gap. The solder alloy 203 may further include a fourth metal, preferably selected from a group of metals including silver, zinc, and indium.

### FIELD OF THE INVENTION

The present invention is related in general to the filed of semiconductor devices and processes, and more specifically to the structure, material selection, and fabrication method of solder joints connecting contact pads, whereby the joints even in fine-pitch vertical interconnects through silicon chips are reliable in drop tests.

### DESCRIPTION OF RELATED ART

When semiconductor packages have to be assembled on boards, it has been common practice to select copper or copper alloys as the base metal for the contact pads of the package as well as of the boards, and to use a tin-based solder to interconnect the pads. The copper pads are manufactured in a wide variety of sizes; at present, the smallest diameter is on the order of 150 μm. Recently, the semiconductor industry has started to use copper to fill via-holes through silicon chips (so-called TSVs) so that the contact diameter of a copper surface may be as small as 25 μm, or even smaller.

For the solder, tin-based solders have traditionally been favored. Since pure tin is melting at 232° C., it is common practice to aim for lower temperatures by adding an admixture metal and forming a solder alloy. In the past, lead has been commonly used as an admixture metal, but is now disfavored for environmental reasons. Alternative admixture metals include silver and copper. The alloy of tin and 3.5 weight % silver has a eutectic melting temperature of 221° C., the alloy of tin and 0.7 weight % copper has a eutectic melting temperature of 227° C., and the alloy of tin and 3.4 weight % silver and 0.8 weight % copper has a eutectic melting temperature of 217° C. A modified tin alloy used by the industry has the admixed metals in the composition of 3.0 weight % silver and 0.2 weight % copper.

In order to ensure that the copper pads can be connected by solder without any interference by a copper oxide film on the contact surface, the contact with a pure copper surface are commonly protected either by an organic solderability preservative (OSP) film, which evaporates before the melting temperature of the solder alloy is reached, or by a stack of coats including nickel and a noble metal such as palladium or gold. For most devices, the nickel coat thickness is in the range from about 0.5 to 2.0 μm or higher. Thick nickel coats are especially practical in semiconductor devices, which have to sustain relatively high temperatures in operation, such as in automobile applications, because thick nickel coats prevent the gradual change of device conditions by diffusion of copper atoms from the pads into the solder. Other devices use nickel coats thinner than 0.5 μm, wherein these nickel coats are referred to as thin nickel. The noble metal coats have typically a thickness less than 0.1 μm so that they are dissolved by the liquefied solder alloy during the assembly process flow. In some semiconductor devices, these protective coats may cover the surface of only one of the contacts, while the other contact exhibits the bare pad metal.

### SUMMARY OF THE INVENTION

In an effort to identify the structure of device contact pads and connecting solder for the best device reliability performance in mechanical drop tests, applicants detected striking differences in the failure rates between device groups of different copper pad structures and solder compositions. Devices of one group had one copper pad protected by stacked coats of nickel and gold, while the other pad was bare copper; the pads were solder-connected by eutectic tin-lead alloy. This group exhibited the earliest failures after about 100 drops. Devices of another group had both copper pads protected by OSP films and the pads solder-connected by eutectic tin-silver-copper alloy; this group showed the earliest failures after about 35 drops. Devices of yet another group had one copper pad protected by stacked coats of nickel and gold, while the other pad was bare copper; the pads were solder-connected by eutectic tin-silver-copper alloy. This group exhibited the earliest failures already after a couple of drops. Devices in yet another group had one copper pad protected by stacked coats of nickel and gold, while the other pad was covered by a layer of thin nickel; the pads were solder-connected by the modified tin-silver-copper alloy. This group also exhibited the earliest failures after only few drops.

Analyzing the failed devices metallurgically under the microscope, applicants discovered that the drop failures were not caused by excessive brittleness, but by a continuous crack, which appeared regularly along the length of continuous layers of different intermetallic compounds. The layer of the intermetallic compound Ni₃Sn₄ (or the intermetallic compound (Ni, Cu)₃Sn₄), in contact with the pad, was separated by a gap from another layer of the intermetallic compound Cu₆Sn₅ (or the intermetallic compound (Cu, Ni, Au)₆Sn₅) in contact with the solder. As the applicants found, the two intermetallic compounds crystallize with different and incompatible lattice constants; consequently, the interface between the two intermetallic layers is under stress and mechanically weak; the intermetallic layers can separate easily in drop tests. On the other hand, applicants found that dispersed clusters of the intermetallic compound Cu₆Sn₅ (or (Cu, Ni, Au)₆Sn₅) do not contribute to failure, when the clusters are localized and randomly distributed in the solder along the Ni₃Sn₄ layer or (Ni, Cu)₃Sn₄ on the pad surface.

Applicants further discovered that even originally Cu-free solder may obtain some Cu content by diffusion from the copper pad into the solder during the assembly process. When the Cu content surpasses the value of about 0.3 weight % in the solder, the Cu-rich intermetallic Cu₆Sn₅ may form as a continuous layer on Ni₃Sn₄ or (Ni, Cu)₃Sn₄. Consequently, the copper diffusion effect has to be controlled in the assembly process to limit the copper content of the solder.

Applicants solved the problems of the early drop failures by selecting interconnect structures and fabrication methods so that only one intermetallic compound (e.g., Ni₃Sn₄) can form as a continuous layer while any other compound (e.g., Cu₆Sn₅) is restricted to form only discontinuous clusters. To that end, the amount of copper in the solder is restricted by covering each pad with metallic barrier layers so that additional copper cannot diffuse from the pad into the solder during the attachment process; the diffusion prevention is determined by the selection of the barrier layer metal and layer thickness and can be specified together with the solder selection.

### BRIEF DESCRIPTION OF THE DRAWINGS

FIG. 1 shows a schematic cross section of a semiconductor device with two stacked chips assembled on a substrate; one of the chips has metal-filled through vias (TSVs). The stacking of the chips and the assembly is accomplished by solder interconnections according to the invention.

FIG. 2 illustrates an enlargement of a portion of the semiconductor device of FIG. 1, depicting detail of the solder interconnection between metal pads according to the invention.

FIG. 3 is a microphotograph showing the metallurgical composition of a portion of the interface between a metallic pad and solder of a device before drop tests. The interface has been formed without the benefit of the invention.

FIG. 4 is a microphotograph showing the metallurgical composition of another portion of the interface between a metallic pad and solder of a device after drop tests. The interface has been formed without the benefit of the invention, and the device has failed the drop test.

### DETAILED DESCRIPTION OF THE PREFERRED EMBODIMENTS

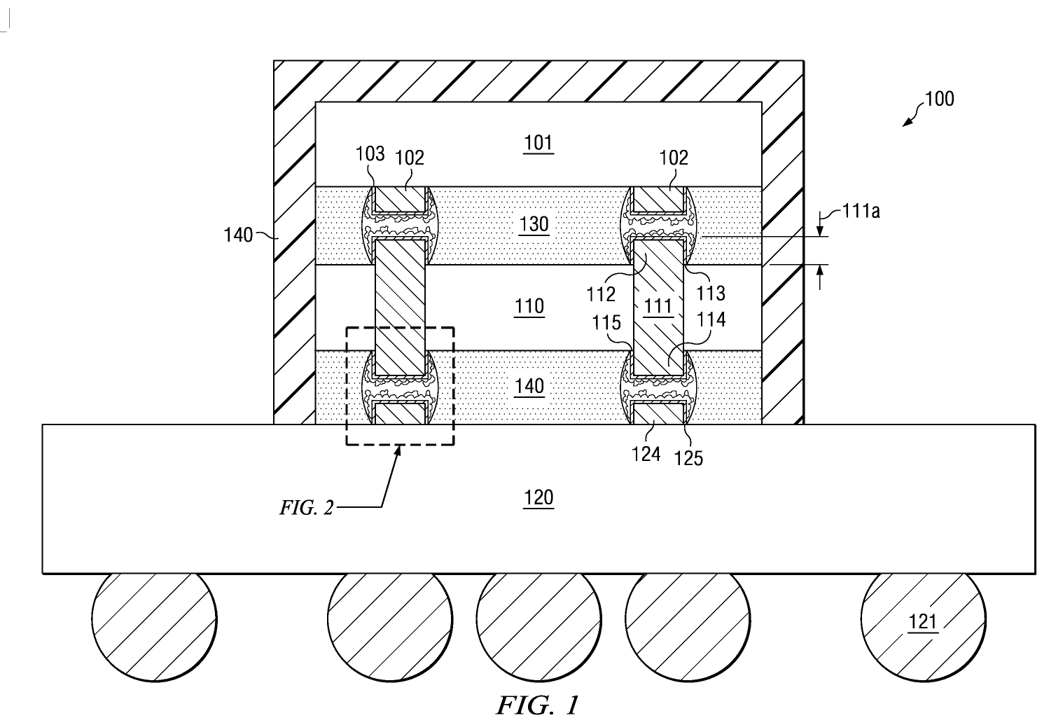

FIG. 1 shows an embodiment of the invention in a schematic cross section of a semiconductor device generally designated 100. The device has a first chip 101 stacked on a second chip 110. The stack is protected by an insulating encapsulation 140 and is assembled of a substrate 120, which has solder bodies 121 for connection to external parts. Substrate 120 is preferably made of an insulating material integral with conductive lines and interconnecting vias (not shown in FIG. 1). First chip 101 has metallic contact pads 102, preferably made of copper or a copper alloy. In order to ensure that the copper of the pads can be connected by solder without interference by a copper oxide film on the contact surface, and that the copper of the pads remains contained to the pad and cannot migrate or diffuse into other portions of the assembly, pads 102 are covered by a metallic coat 103, preferably nickel in the thickness range from about 0.5 to 2.0 μm or higher.

Second chip 110 has conductive via holes through the thickness of the chip; the vias are commonly referred to as TSVs (through-silicon vias). Towards the semiconductor material, the via holes are lined with an insulating film (not shown in FIG. 1); inside of the insulating film, the volume of each via hole is filled with a metal post 111, preferably copper or a copper alloy. The diameter of the TSV is typically about 25 μm; the technology trend is towards smaller diameters. As FIG. 1 illustrates, the copper posts of the TSVs protrude on both surfaces of chip 110 a certain length 111 a to form contact pads 112 on one side and contact pads 114 on the opposite side of chip 110. For the same reasons as listed for first chip 101 (ensured solderablity and blocked migration), the pads 112 and 114 of the second chip 110 are covered by a metallic coat; in FIG. 1, the coats for pads 112 are designated 113 and the coats for pads 114 are designated 115. The coats are preferably made of nickel in the thickness range from about 0.5 to 2.0 μm. As FIG. 1 indicates, the diameter of metal post 111 determines not only the size of contact pad 112, but preferably also the size contact 103 of the first chip 101. In some device, however, pads 102 may have larger diameters than the diameter of the posts.

Contact pads 112 are aligned with contact pads 102 so that they can be connected by solder to form a contact joint. Device reliability requires that these joints retain not only electrical conductivity for the life of the device, but are also mechanically robust enough to withstand drop tests and thermo-mechanical stress in temperature swings. More detail about fabrication and characteristics of the solder joints below. The space gap between chips 101 and 110 and especially around the solder joints is preferably filled with a polymer compound 130 loaded with inorganic filler particles (so-called underfill compound), in order to support the distribution of thermomechanical stress on the joints and thus to enhance joint reliability.

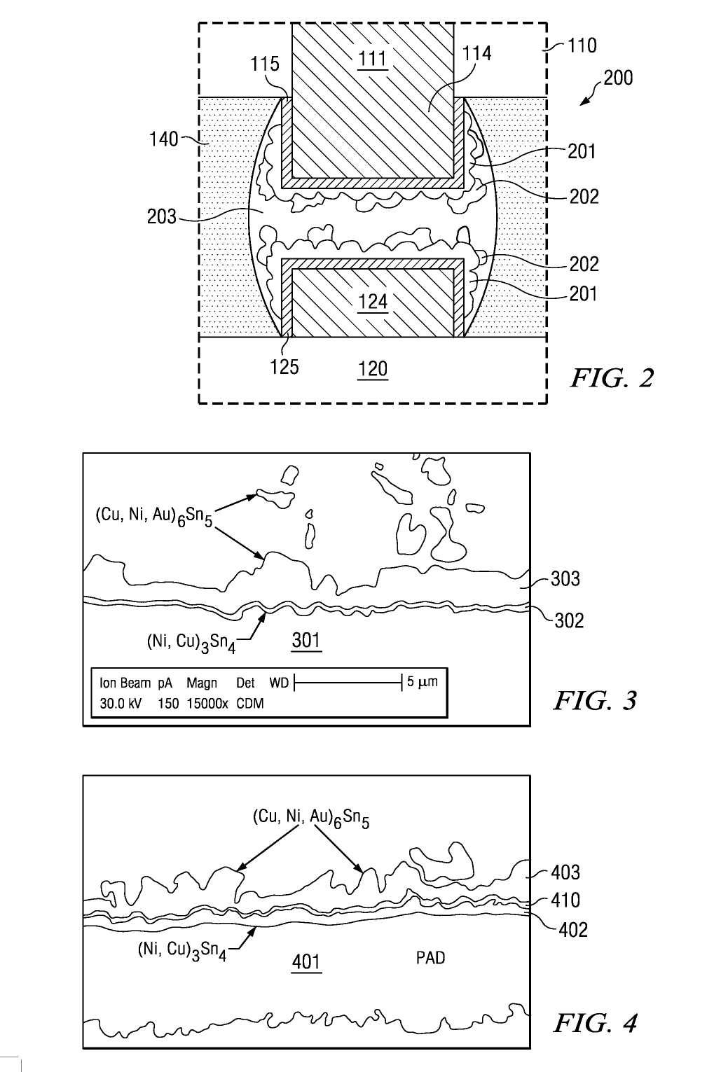

As FIG. 1 indicates, substrate 120 has contact pads 124, preferably made of copper or a copper alloy. In order to ensure solderability of the pads and to block migration of the copper, pads 124 are covered by a metallic coat 125, preferably made of nickel in the thickness range from about 0.5 to 2.0 μm. Contact pads 124 are aligned with contact pads 114 so that they can be connected by solder to form a contact joint. Device reliability requires that these joints retain not only electrical conductivity for the life of the device, but are also mechanically robust enough to withstand drop tests and thermo-mechanical stress in temperature swings. One of the joints in FIG. 1 is marked “FIG. 2” for the enlargement in FIG. 2 to describe in more detail the characteristics and fabrication of the solder joints according to the invention. The space gap between chip 110 and substrate 120 and especially around the solder joints is preferably filled with a polymer compound 140 loaded with inorganic filler particles (so-called underfill compound), in order to support the distribution of thermomechanical stress on the joints and thus to enhance joint reliability. Compound 140 is preferably the same as compound 130.

FIG. 2 illustrates a schematic cross section of a solder joint, generally designated 200, according to the invention. The solder joint has a first contact pad 114 and a second contact pad 124 of a first metal, preferably copper or a copper alloy, facing each other across a gap. A coat (115 and 125, respectively) of a second metal, preferably nickel, covers each pad. A layer 201 of crystals of first intermetallic compounds, such as Ni₃Sn₄ and (Ni, Cu)₃Sn₄, covers the surface of each coat. Isolated crystals 202 of second intermetallic compounds, such as Cu₆Sn₅ and (Cu, Ni)₆Sn₅, different from the first intermetallic compounds, are dispersed on top of the layer 201 of crystals of the first intermetallic compounds. A solder alloy 203 including a third metal, preferably tin, and the first metal fills the gap. The solder alloy 203 may further include a fourth metal, preferably selected from a group of metals including silver, zinc, and indium. In this case, crystals of the fourth and the second metal (for example, Ag₃Sn) are located on top of the layer 201 of crystals in a fashion similar to the location of the isolated crystals 202 of second intermetallic compounds shown in FIG. 2.

The coat (115, 125) over the pad (114, 124) serves two purposes: It prevents atoms of the pad metal to migrate, or diffuse, away from the pad, and it ensures solderability of the pad. To suppress the outdiffusion of copper atoms, a nickel layer (115, 125) over a copper pad (114, 124) in the thickness range from about 0.5 to 2.0 μm is generally sufficient as a barrier; even thinner nickel layer can be employed. If there are, however, additional requirements such as the device operation at temperatures substantially elevated over ambient temperature, as in automotive applications, nickel layers thicker than 25 μm are advisable. The prevent copper diffusion from the pads into the solder, both pads 114 and 124 have to be covered by a coat layer (115 and 125, respectively), and a dissolvable coat such as a film of OSP (organic solderability preservative) is not sufficient.

The enhance the solderability of the pads, a layer of a noble metal such as palladium or gold less than 0.1 μm thick over the nickel is helpful. This coat of non-oxidizing metal is dissolved into the liquid solder at the melting temperature of the solder alloy.

Solders 203 based on tin (melting temperature 232° C.) are preferably alloyed with at least one other admixture metal, and avoid lead. Alternative admixture metals preferably include copper and silver. The alloy of tin and 0.7 weight % copper has a eutectic melting temperature of 227° C., the alloy of tin and 3.5 weight % silver has a eutectic melting temperature of 221° C., and the alloy of tin and 3.4 weight % silver and 0.8 weight % copper has a eutectic melting temperature of 217° C. A modified tin alloy used by the industry has the admixed metals in the composition of 3.0 weight % silver and 0.2 weight % copper.

Referring to FIG. 2, applicants have discovered that for solders containing tin and copper, the amount of copper in the solder alloy has to be limited to about 0.3% weight percent or less of the solder, if the crystals 202 of the second intermetallic compounds on top of the layer 201 of crystals of the first intermetallic compounds are to be kept isolated and to be prevented from forming a layer of the second intermetallic compounds. When the formation of two layers would be allowed to happen, the interface between the two intermetallic layers would be under stress and thus mechanically weak, because the two layers comprise crystals with different and incompatible lattice constants. Consequently, the two layers of intermetallic crystals could separate easily in mechanical drop tests and thus fail reliability requirements.

An example of such failure by a crack along fully formed layers of crystals of the first and second intermetallic compounds, respectively, is illustrated in the metallurgical micrographs of FIGS. 3 and 4. FIG. 3 shows a portion of the pad and the adjoining solder region before the drop test, and FIG. 4 shows a pad adjoining solder portion after a few drop tests. The bottom material in both figures belongs to the nickel coat (301 and 401, respectively) covering the copper pad. In contact with the nickel coats of the pads are the (relatively thin) layers (302 and 402, respectively) of crystals of the first intermetallic compounds (Ni, Cu)₃Sn₄. These layers are joined by fully formed layers (303 and 403, respectively) of crystals of the second intermetallic compounds (Cu, Ni, Au)₆Sn₅. As FIG. 4 depicts, the presence of a fully formed layer of crystals of the second intermetallic compounds results in a catastrophic delamination of the joint layers by crack 410.

As stated above in conjunction with FIG. 2 for tin-copper alloy solder joints of copper pads with nickel layer coats, the layer 201 of crystals of first intermetallic compounds covering the surface of each coat include (Ni, Cu)₃Sn₄ crystals and the isolated crystals 202 of second intermetallic compounds, distributed on top of the layer 201 of crystals, include Cu₆Sn₅ and (Cu, Ni)₆Sn₅ crystals. When the solder further includes silver, the isolated crystals distributed on top of layer 201 further include Ag₃Sn intermetallic compound. In analogous fashion, when the solder includes zinc instead of silver, the isolated crystals distributed on top of layer 201 include zinc-copper and zinc-nickel intermetallic compounds. Similarly, when the solder includes indium instead of silver, the isolated crystals distributed on top of layer 201 include indium-tin intermetallic compounds.

Another embodiment of the invention is a method for assembling a solder joint with robust characteristics relative to mechanical drop tests. The first and the second pad to be assembled are aligned across a gap; preferably, the pads are made of copper or a copper alloy. A coat, preferably made of nickel, is deposited over each pad; the coat serves to prevent the out-diffusion of copper atoms from the pads and to facilitate the solderability of the pads. To further enhance the solderability, another thin layer of a noble metal such palladium or gold may be deposited over the nickel.

In the next process step, a solder alloy is applied to one of the coated pads. A preferred method is the screen-printing of the solder paste. Alternatively, the solder paste may be deposited on one of the pads and reflowed for a first time. The solder alloy preferably includes tin and copper; it may further include another metal, preferably silver; alternatively, the solder may include zinc or indium. Care is taken in the selection of the solder alloy to limit the copper content of the alloy to about 0.3 weight % or less of the solder weight.

Next, the coated pad with the solder is brought into contact with the other coated pad so that the gap is closed. Thermal energy is then supplied to the assembly in order to elevate the assembly temperature from ambient temperature to the melting temperature of the solder alloy (preferably, to a temperature slightly higher than the melting temperature). When the solder alloy is liquid, several process steps are progressing concurrently the steps include:

A layer of crystals of first intermetallic compounds, such as (Ni, Cu)₃Sn₄, is formed to cover the surface of each nickel coat on the copper pad. Further, isolated crystals of second intermetallic compounds, such as (Cu, Ni)₆Sn₅ and Ag₃Sn, different from the first intermetallic compounds are formed on top of the layer of crystals of first intermetallic compounds. Since no additional copper can be added from the coated pads, the limited supply of copper from the solder alloy prevents the formation of a layer of crystals of second intermetallic compounds. Further, an alloy of solder is formed between the isolated crystals, the alloy including the residual of the solder at the start of the process flow. Finally, the temperature is lowered again the ambient temperature.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. As an example, the invention applies to copper contacts of any semiconductor device and is not limited to devices with copper-filled through-silicon vias. Further the invention applies to any solder contact, in which the formation of intermetallic layers need to be limited to a single layer in order to prevent the stress at the interface of two intermetallic layers in contact.

It is therefore intended that the appended claims encompass any such modifications or embodiments.

We claim:

1. An apparatus comprising:
a first and a second pad of a first metal facing each other across a gap;
a coat of a second metal covering each pad;
a layer of crystals of first intermetallic compounds covering the surface of each coat;
isolated crystals of second intermetallic compounds different from the first intermetallic compounds dispersed on top of the layer of crystals of first intermetallic compounds; and
a solder alloy including a third metal and the first metal filling the gap.

2. The apparatus of claim 1 wherein the first metal includes copper.

3. The apparatus of claim 2 wherein the second metal includes nickel.

4. The apparatus of claim 3 wherein the third metal includes tin.

5. The apparatus of claim 4 wherein the layer of crystals of the first intermetallic compounds includes crystals of Ni₃Sn₄ and crystals of (Ni, Cu)₃Sn₄.

6. The apparatus of claim 5 wherein the isolated crystals of the second intermetallic compounds include Cu₆Sn₅ and (Cu, Ni)₆Sn₅.

7. The apparatus of claim 6 wherein the solder alloy further includes a fourth metal.

8. The apparatus of claim 7 wherein the fourth metal is selected from a group of metals including silver, zinc, and indium.

9. The apparatus of claim 8 further including crystals of the fourth and the second metal located on top of the layer of crystals.

10. The apparatus of claim 9 wherein the crystals of the fourth and the second metal include Ag₃Sn.

11. A method for assembling an apparatus comprising the steps of:
aligning a first and a second pad of a first metal across a gap;
depositing a coat of a second metal over each pad;
applying a solder alloy including a third metal and the first metal on the first pad;
bringing the second pad in contact with the solder, thereby closing the gap;
forming a layer of crystals of first intermetallic compounds to cover the surface of each coat;
forming isolated crystals of second intermetallic compounds different from the first intermetallic compounds on top of the layer of crystals of first intermetallic compounds; and
forming an alloy between the isolated crystals.

12. The method of claim 11 wherein the steps of forming a layer, forming isolated crystals, and forming an alloy are performed concurrently at the melting temperature of the solder alloy.

13. The method of claim 12 wherein the first metal includes copper.

14. The method of claim 13 wherein the second metal includes nickel.

15. The method of claim 14 wherein the third metal includes tin.

16. The method of claim 15 wherein, for copper as first metal and tin as third metal, the amount of copper in the solder is about 0.3 weight % or less of the solder.

17. The method of claim 16 wherein the layer of crystals of the first intermetallic compounds includes crystals of Ni₃Sn₄ and crystals of (Ni, Cu)₃Sn₄.

18. The method of claim 17 wherein the isolated crystals of the second intermetallic compounds include Cu₆Sn₅ and (Cu, Ni)₆Sn₅.

19. The method of claim 18 wherein the solder alloy further includes a fourth metal.

20. The method of claim 19 wherein the fourth metal is selected from a group of metals including silver, zinc, and indium.

21. The method of claim 20 further including crystals of the fourth and the second metal located on top of the layer of crystals.

22. The method of claim 21 wherein the crystals of the fourth and the second metal include Ag₃Sn.
